(19) United States
(12) Patent Application Publication
(10) Pub. No.: US 2015/0291902 A1
(43) Pub. Date: Oct. 15, 2015

(54) METHOD TO IMPROVE THE EFFICIENCY OF REMOVAL OF LIQUID WATER FROM SOLID BULK FUEL MATERIALS

(71) Applicant: GTL Energy Holdings Pty Limited, Unley (AU)

(72) Inventors: Robert R. French, Wellington, CO (US); Robert A. Reeves, Arvada, CO (US)

(21) Appl. No.: 14/525,600

(22) Filed: Oct. 28, 2014

Related U.S. Application Data
(63) Continuation of application No. 12/047,641, filed on Mar. 13, 2008, now abandoned.
(60) Provisional application No. 60/980,780, filed on Oct. 17, 2007.
(60) Provisional application No. 60/894,591, filed on Mar. 13, 2007.

(51) Int. Cl. C10L 5/04; C10L 5/36; C10L 5/08; F26B 11/02; F26B 15/00

(52) U.S. Cl. CPC C10L 5/04; F26B 11/028; F26B 15/00; C10L 5/08; C10L 5/361; F26B 2200/08; C10L 2290/08; C10L 2290/30

(57) ABSTRACT

The invention provides methods to efficiently reduce the water concentration of raw solid fuels, including low rank coals such as brown coal, lignite, subbituminous coal, and other carbonaceous solids. Efficiently drying these materials at low temperatures significantly reduces greenhouse gas emissions and allows the production of low-rank coals for gasification and liquifaction.

### CROSS REFERENCE TO RELATED APPLICATION

This application claims the benefit of priority under 35 U.S.C. §119(e) to U.S. Provisional Patent Application No. 60/894,591 filed Mar. 13, 2007, and to U.S. Provisional Patent Application No. 60/980,780 filed Oct. 17, 2007, both of which are incorporated herein by reference.

### FIELD OF THE INVENTION

This invention describes a method to efficiently reduce the moisture content of solid carbonaceous materials including brown coal, lignite and subbituminous coal to produce premium-quality fuels.

### BACKGROUND OF THE INVENTION

Low-rank coals (LRCs) are abundant in the United States and elsewhere and have the potential to provide an economic feedstock for gasification. LRCs typically contain between 25 and 45 wt % moisture in the United States, and can be as great as 65 wt % in other countries. The high moisture content of LRCs has impeded their use as gasification feedstock because the gasification industry has identified an optimum moisture content not exceeding 15 wt %. If the feedstock moisture is greater than 15 wt %, plant efficiency is impaired and economics may not be viable. A LRC with high-moisture content emits more carbon dioxide during utilization, on an equal energy basis, than low-moisture bituminous coal because the extra energy consumed evaporating moisture contained in the LRC is not available for useful work. Efficiency is reduced and emissions are increased.

Coal gasification systems produce clean burning gas and liquid fuels from solid fuels including coal and lignite. This technology is especially attractive from an environmental standpoint because carbon dioxide, believed to be an agent of global climate change, can be concentrated and removed during processing. Clean burning synthetic natural gas (SNG) is available for residential and industrial use. However, the yield of liquids such as diesel and naphtha that are produced by gasification and liquefaction processes is severely impaired as the moisture of the feedstock increases above 12 wt %. The costs imposed by limiting feedstock to less than 12 wt % moisture severely reduce the ability to use LRCs to produce petroleum liquids and gases.

Various methods have been employed by commercial entities and evaluated by research laboratories to reduce the moisture content of LRCs. Virtually all require thermal energy to sufficiently heat the LRC to evaporate water and remove the superheated vapor from the dried solids. Some methods use an autoclave or pressure vessel to remove a portion of the water as a high-pressure superheated liquid.

The high-temperature (above 200° C.) thermal process uses an external heat source to produce a working fluid such as air, combustion flue gas, steam, or other inert gases. Steam generators, combustors, stoker furnaces, or gas or oil burners are required to heat the working fluid to the high temperature. The cost of these external energy sources can be great, especially when environmental equipment is included to treat flue gases created during combustion.

In an attempt to reduce the cost of high-temperature thermal energy from external heat sources, experiments have been conducted to extract low-temperature (less than 100° C.) thermal energy from waste heat sources such as power plant condenser circuits, low-pressure steam cycles, flares, and thermal oxidizer flue gases.

The low-temperature drying methods require more time to evaporate a given amount of water than the high-temperature methods. Therefore a substantially larger drying vessel is required to provide the residence time to evaporate the water. The expense of the larger drying vessel and ancillary equipment is often greater than the benefit gained from using a low-temperature waste energy source to heat the working fluid.

Certain LRC's are heat sensitive and are easily oxidized during drying. Oxidation also reduces the useful energy contained in the dried product, and therefore reduces its commercial value. The rate of oxidation can be reduced by drying at relatively low temperature, preferably less than 100° C.

Commercial drying systems require substantially more energy to evaporate the water contained in LRCs than that required to evaporate an equal amount of liquid water held in direct contact with the working fluid. This fact can be explained by considering how liquid water is held by the LRC:
1. Water residing on the surface of the LRC particle.
2. Water held in the interior pores of the LRC particle.

Water that is chemically bound to organic and inorganic molecules is not relevant to the present invention because this form of water can only be removed by thermal energy.

Water residing on the surface of the LRC particle is the easiest to evaporate because it comes into direct contact with the working fluid. Because little heat is transferred into the solid LRC particle during this operation, evaporation of this surface moisture is efficient and rapid. More energy is required to remove water held in pores of the bulk material because a sufficient amount of thermal energy must be imparted by the working fluid to both evaporate water and heat the porous solid material to evaporation temperatures.

Therefore the total energy required to evaporate liquid water held by LRC is the sum of the energy required to evaporate and remove water residing on the surface and within the pores of the material. The sum is always greater using existing thermal drying systems than that required to evaporate the equivalent amount of liquid water from the surface of a solid in contact with a working fluid.

### SUMMARY OF THE INVENTION

The present invention improves the efficiency of thermal drying methods by evaporating liquid water that was transferred to the surface of the particle from interior pores during compaction by mechanical forces. Increased efficiencies result because water residing on the surface that is direct contact with the working fluid can be evaporated with less time and energy than water residing in the material's internal pores. The present invention transforms LRC to remove moisture, and in a gasification application, improves the gasification characteristics of raw LRC feedstock.

Most LRCs have porous structures that contain liquid water and other tightly held materials. The process described in U.S. patent application Ser. No. 11/380,884, filed Apr. 28, 2006 (U.S. Patent Publication No. 2007-0023549 A1), which is incorporated herein by reference, compresses raw material to reduce pore volume and express a significant proportion of the water contained in the pore volume. The high compaction forces permanently deform the raw feed to produce a nearly solid impermeable product that is less susceptible to reabsorb water and oxygen. This transformation, when conducted on finely sized raw feed materials, has proven useful to both reduce the moisture content of feedstock and modify the texture of the material.

In the present invention, high compaction forces are continuously imparted at ambient temperature to the feed material. Sufficient force is used to collapse the material's porous structure and force the expelled water to the surface of the compacted material. The wet compacted material is then fed to a low-temperature or ambient temperature-drying device where a substantial proportion of the water is evaporated from the surface of the material. As an additional benefit, the present invention, by being more efficient, can dry materials at ambient temperatures that are too low to be economically practical with conventional thermal drying systems that do not treat the feed prior to drying. Operating the present invention at ambient temperatures will provide additional desirable cost advantages to the utility and gasification industries, among others, by allowing production and use of low cost dried LRC products. Benefits include, via increased drying efficiencies, reducing the amount of carbon dioxide and other gaseous pollutants such as sulfur dioxide and nitrous oxides released during production and utilization. Providing the opportunity to economically use domestic LRC resources to produce motor fuels will substantially reduce use of foreign oil. Thus the present invention proves beneficial in three ways: economically reducing moisture content below 15 wt %, forming a briquette that has predictable reaction kinetics with steam and oxygen, and providing a strong material that can support the weight of burden held in the gasification reactor.

The present invention provides processing methods to efficiently process raw bulk materials into low-moisture content products. The present invention includes the following subsystems:
1. Raw solid fuel preparation.
2. Material compaction.
3. Working fluid management.
4. Drying.
5. Dust collection.
6. Optional secondary compaction means to form the material into desired shapes, as may be required by specific applications

Raw materials, such as LRC's are often mined and crushed to 50 mm top size, a size typically traded worldwide. The raw materials are typically carbonaceous materials and particularly carbonaceous fuels that may include brown coal, lignite, subbituminous coal, waste coals and mixtures of these materials. The present invention receives this carbonaceous material and crushes it to pass a 5 mm screen or other similar size, depending on the application. Preferably, the feedstock is crushed to reduce its nominal top size to between 0.1 mm to 6 mm, and more preferably to a nominal top size of about 0.5 mm. The present invention processes all of the feed material, thus achieving greater recovery of resources than other drying techniques that must remove and potentially discard finely sized materials prior to processing.

The feed material is then compacted using an applied mechanical force sufficient to deform the feedstock to reduce its pore volume. Preferably, the force applied is in the range of between 5,000 lb/in² and 50,000 lb/in², and more preferably the applied force is about 30,000 lb/in². The prepared feed material may be fed to compactors, such as roll presses, that exert high pressures on the material. The pressures exerted by the roll presses may range as high as 275,000 kPa per cm of roll width. The material is physically transformed under the pressure to collapse the porous structures that are present in most LRC's. The pores contain water, which collapse under pressure, forcing the water from the pores to the surface of the material. In some cases, sufficient water is present in the bulk starting material to be removed from the compressed material as a liquid and be carried away from the processing stream. Separating liquid water from the material prior to drying reduces the thermal load on the system.

The wet compacted material is transported to low-temperature processing, such as an indirect rotary dryer to evaporate the liquid water present on or near the surface of the compressed particles. Drying rates of compacted materials can be many times greater than drying rates of the raw material before compaction. The reason for the increased drying rate is the water expressed from the pores is in direct contact with unsaturated gas (“working fluid” as defined below) passing over the material. Increasing drying rates at low temperatures provides the operator with several benefits not offered by traditional processes. For example, smaller and less costly equipment can be used to achieve the desired capacity. If costs do not constrain the operation, greater capacity can be achieved with compaction. Lower working temperatures can be used to dry heat-sensitive materials, thereby avoiding or substantially reducing oxidation and product deterioration.

In another embodiment of the invention, a covered open stockpile can be used to gently but efficiently dry compacted material. Experiments reveal that the stockpiled material can be well managed because oxidation rates of LRC's can be greatly reduced by compaction.

The low-temperature drying process requires a source of unsaturated gas (working fluid) to heat the compacted material and transport the superheated water vapor away from the dried material. Heat sources can range from ambient air to gas supplied from electric heaters, gas- and other fossil-fired combustors, and waste heat available from existing industrial processes such as power plants. Management of the heat source can be affected by readily-available commercial equipment.

Spent working fluid, containing the water removed by evaporation, often contains dust that must be collected and processed to meet environmental regulations. Experiments by the present inventors have confirmed that the spent working fluid produced during low-temperature drying does not contain significant organic vapors to require additional collection or thermal treatment. Substantial cost savings result. In one embodiment, collected dust can be introduced, or re-introduced, to the compaction operation to increase product yield.

Dried product may be transformed into desired shapes, such as briquettes, that can be readily handled, stored, and transported by rail or ship to distant customers. The formed shapes may be desired to provide favorable material handling properties including acceptable bulk density, reduced breakage and dust generation, and resistance to oxidation during storage.

Numerous gasification processes have been identified and developed. One such process that has commercial application processes solid feedstock to produce carbon monoxide and hydrogen (referred to as syngas) and slag as a waste product. The process vessel resembles a tall vertical tank that accepts feed at the top of the vessel. Oxygen and steam are injected near the bottom of the vessel (reaction zone) to create exothermic reactions that produce syngas. The feed slowly descends the vessel as material is consumed in the reaction zone. New feed is continuously added to make up volume consumed. The efficiency of the reactions depends on the feed material maintaining sufficient mechanical strength to support its bulk weight and porosity to allow gases to flow upward and out of the reaction vessel. An ideal feed therefore contains an optimum moisture content (less than 15 wt %), and produce a carbonized material (coke) with exceptional mechanical strength and stability. In addition, the texture (grain size) of the feed material is specified to provide the desired reaction rate between the coke, oxygen, and steam.

Briquettes produced from LRC by the processes of the present invention have proven to be beneficial as a gasifier feedstock because of its ideal moisture content (8-15 wt %), mechanical strength after coking (greater than 600 lb/in2 compressive strength at ambient temperature), and moderate rate of reaction with steam at high temperature.

The operating conditions operating conditions of the processes of the present invention can be adjusted to provide briquette products with the specified moisture content, strength, and texture.

### BRIEF DESCRIPTION OF THE DRAWINGS

FIG. 1 shows a schematic drawing of a low-temperature drying process integrated into a typical fossil-fired power plant operation in which a source of waste heat is available to heat the working fluid.

FIG. 2 shows a schematic drawing of low-temperature drying process that can be independently sited where no waste heat is available. Ambient air provides the working medium.

FIG. 3 shows a schematic drawing of low-temperature drying process that can be independently sited and uses an external heat source to provide warm air for drying.

FIG. 4 shows a schematic drawing of an ambient-temperature drying process that can be independently sited where material is stored in a covered stockpile. The stockpile is managed to accept compacted material on a continuous basis and be reclaimed as required.

FIG. 5 is a graph showing the results of a study comparing the relative drying rates of raw lignite and compacted lignite.

### DETAILED DESCRIPTION OF THE INVENTION

The present invention provides a novel method to treat solid carbonaceous materials such as lignite and subbituminous coal used to fire boilers, combustors, stokers, and to feed coal gasifiers. This method takes advantage of the fact that a significant proportion of the water contained in pores of low-rank coal (often as much as 74% of the total water) can be efficiently evaporated without the difficulties of the conventional thermal drying systems. Conventional drying operations must heat the solids to evaporation temperatures to remove water held in the interior of the material. Because the rate of drying is greater with the present invention, lower temperatures can be efficiently used, significantly reducing material oxidation.

The method continuously compacts and collapses the porous material to express water held in pores, and transfers the expressed water to the surface of the processed material. Water residing on the surface is efficiently evaporated in the presence of the working fluid. By avoiding the difficulties associated with heat and mass transfer into and out of a particle, the present invention provides the superior heat and mass transfer only available when water is placed in direct contact with a working fluid. The efficiency gains can make both ambient-temperature and elevated-temperature drying systems practical in many applications.

The present invention includes the following subsystems:
1. Raw solid fuel preparation.
2. Material compaction.
3. Working fluid management.
4. Drying.
5. Dust collection.
6. Optional secondary compaction to form the dried product into desired shapes, as may be required for certain commercial or industrial applications.

Each of these subsystems is described in detail below.

### Raw Solid Fuel Preparation

The raw solid fuel preparation subsystem receives crushed material of traditional trade top size, typically about 50 mm. In one preferred embodiment, the minus-50 mm raw solid fuel is comminuted by a hammer mill, roll crusher, or other appropriate device to produce a product of approximately 5 mm top size. The optimum particle size required to provide the desired compaction properties is experimentally determined for a particular application and feed source. However, feed to the compactor may have a top size that typically varies between about 0.1 mm and about 19 mm. Preferably, the top size is about 0.5 mm. The crushed material may include carbonaceous materials such as brown coal, lignite, subbituminous coal, waste coals and mixtures of these materials. Preferably, this raw feedstock contains between about 15 weight percent moisture and about 65 weight percent moisture, and more preferably about 35 weight percent moisture. Preferably, the temperature of this raw feedstock is between about 17° C. and about 66° C., and more preferably the feedstock is at ambient temperature.

### Primary Material Compaction

The prepared bulk raw material is compacted with sufficient force to mobilize and transfer waters held in fractures, voids, and pores from the interior of the solid particle to the surface of the solid particle. Preferably, the compaction of the pre pared bulk raw material is conducted in a continuous manner. The compaction force produces a pressure of between about 5000 lb/in² and about 50000 lb/in², and more preferably the compaction force produced is about 30000 lb/in².

In the preferred embodiment, a roller press is used to compact the feed material using a specific roll force between about 5 kN/cm and about 150 kN/cm of roll width. Water driven from the interior to the surface of particles by these compaction forces therefore becomes readily available for contact with a working fluid.

### Working Fluid Management

The working fluid can be unsaturated air, nitrogen, inert gas, flue gas, superheated steam, or other substances that are compatible with the dried material. The working fluid management system generates a substance containing less than 100% relative humidity. In a preferred embodiment, the substance is air containing less 100% relative humidity that is collected and contacted with the wet material using natural convection, fans, or blowers. In these cases, the entire drying system is independent of external heat sources. The material can contact the working fluid in stockpiles and drying vessels such as a rotary dryer. In another embodiment, the working fluid can be heated by an external source. Supplied heat may be transferred to the working fluid by a heat exchanger. The heat exchanger is configured to suit the application. Sources of external heat may include, for example, condenser cooling water, flue gas desulfurization sludge, gasifier cooling water, syngas cooling water, heat recovery steam generator, or other forms of heat that would otherwise be rejected to the environment. In yet another embodiment, the working fluid generated by an external heat source can be hot flue gas that is tempered with air, or other material that is at a lower temperature than the combustion gas. In yet another related embodiment, a purpose-built boiler or combustor can be used to heat the working fluid.

### Drying

The compacted product, usually in flake or pellet form, is transferred to a vessel where feed particles can be efficiently contacted with the unsaturated working fluid. In a preferred embodiment that works with coal or other heat-sensitive applications, the drying vessel is an indirect rotary dryer. Indirect rotary dryers transfer heat into the wet compressed material in two ways. First, heat is transferred by convection. This is accomplished by passing hot working fluid over the wet material. Second, heat is transferred by conduction by contacting the wet compressed material with a hot surface (shell of the rotary dryer). Both sources of heat evaporate water. In other applications that work with materials that are not heat sensitive, a direct rotary dryer may be used. Direct dryers use heat supplied by the hot working fluid alone, and do not heat the material by conduction. The working fluid used in a direct dryer is typically hotter than the working fluid used in an indirect rotary dryer.

In another embodiment, unsaturated air can be directed across a stockpile of compacted material. Fans or natural convection can used to accelerate the air to increase the rate of drying.

In another embodiment, material can be conveyed on a vibrating pan conveyor fitted with a perforated screen deck. Working fluid enters upward though the perforations and flows past the conveyed material. The conveyor device is sufficiently long to provide the required residence time to dry the material. Saturated vapor is removed from the top of the conveyer. Additional methods including fluid bed dryers and other vessels of commercial configuration are available. The present invention is not limited to the type of style of drying vessel as long as it is compatible with the process material.

### Dust Collection

Vapors emanated from the dryer often contain dust that must be removed before venting to the atmosphere. Standard dust separation and collection devices such as electrostatic precipitators, bag houses or wet scrubbers may be used to separate fine particles from water vapors as dictated by the application. Collected fine particles may be recycled to the compaction subsystem as desired, so that all, or nearly all, feed material is processed without waste.

### Secondary Material Compaction

Applications that require the finished product to be of a specified shape, such as a briquette, can be accommodated by compacting the dried product as described above. Formed products are typically used where the dried material is transported, or used in stoker furnaces where a coarse particle size distribution is required.

In instances in which a shaped final product is desired, the product is preferably a briquette of ovoid shape with a minor dimension of at least about 6 mm, but less than about 100 mm, and more preferably having a minor dimension of about 50 mm. These shaped products are preferably formed bulk materials having a void space of between about 12 volume percent and about 60 volume percent, and more preferably having a void space of about 30 volume percent void space. Preferably, the shaped products are formed such that upon being subjected to coking conditions, they form coke that has a compressive strength between about 100 lb/in² and about 2,000 lb/in², and more preferably a compressive strength of about 800 lb/in². Preferably, the shaped products have a total moisture content between about 7 weight percent and about 17 weight percent, and more preferably a total moisture content of about 12 wt %.

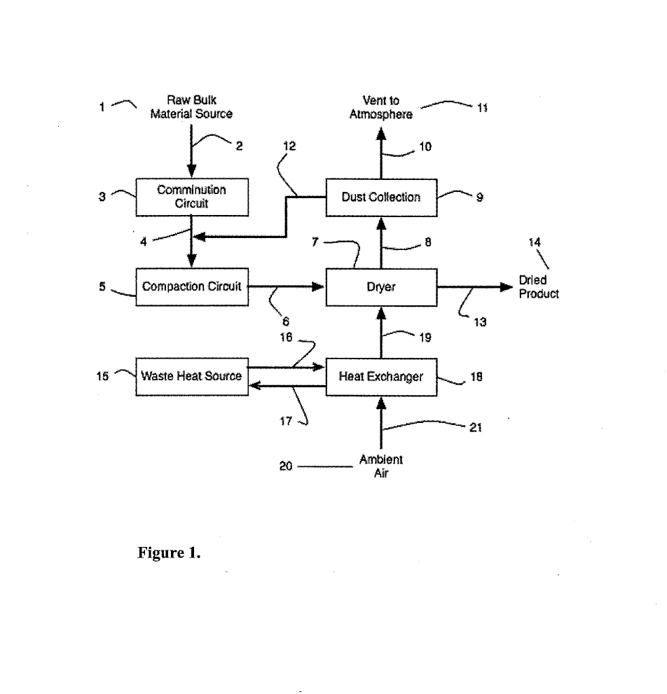

FIG. 1 shows a schematic of the overall system of a preferred embodiment of the invention. A source of raw solid fuel (1) supplies material (2) to the raw solid fuel comminution circuit (3) where the feed is crushed and sized. The prepared raw feed (4) and collected dust (12) are feed to the compaction circuit (5) where they are compressed under high pressure to force water from its internal pores to produce a flake product with water adhering to the surface of the compacted material (6). The compacted material is fed to the dryer (7) where it is mixed with heated air (19), evaporating the water residing on the surface of the compacted material. The resulting vapors and dust (8) are passed to a dust collection circuit (9) where the dust and water vapor are separated. Dust-free vapor (10) is vented to the atmosphere (11). Dust (12) is conveyed to the compaction circuit. Dryer product (13) containing substantially less moisture than the feed, but within the application product specifications, is conveyed to a dried product storage point (14) where it is available for use or additional processing. A source of waste heat (15) capable of supplying sufficient power to satisfy the evaporative load provides a hot flow input (16) and accepts a hot flow return (17). A sufficient temperature drop exists between the input and return flows to impart the required energy to the working fluid (21). An ambient air source (20) provides the cool working fluid (21) to the heat exchanger (18) where it is heated to a specified temperature by the circulating hot in and hot out flows. The heated working fluid (19) passes to the dryer where it contacts the wet feed material.

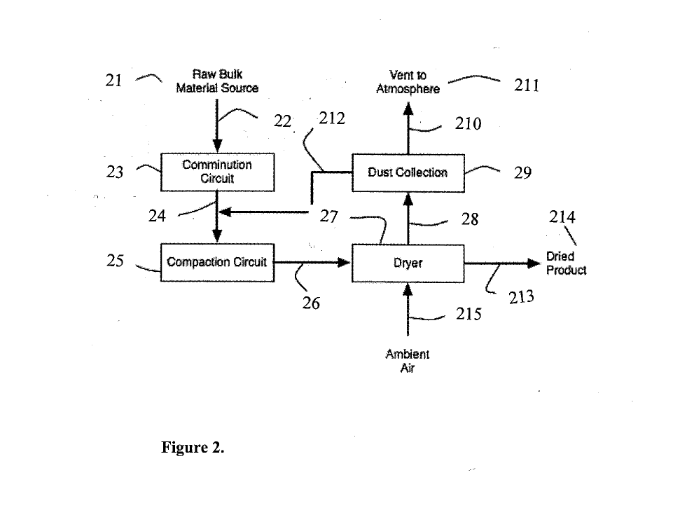

FIG. 2 shows a schematic of the overall system of a preferred embodiment of the present invention. A source of raw solid fuel (21) supplies material (22) to the raw solid fuel comminution circuit (23) where the feed is crushed and sized. The prepared raw feed (24) and collected dust (212) is feed to the compaction circuit (25) where it is compressed under high pressure to force water from the feed's internal pores to produce a flake product with water adhering to the surface of the compacted material (26). The compacted material is fed to the dryer (27) where it is mixed with unsaturated ambient-temperature air (215) thus evaporating the water residing on the surface of the compacted material. The resulting vapors and dust (28) are passed to a dust collection circuit (29) where dust and water vapor is separated. Dust-free vapor (210) is vented to the atmosphere (211). Dust (212) is conveyed to the compaction circuit. Dryer product (213) containing substantially less moisture than the feed, but within the application product specifications, is conveyed to a dried product storage point (214) where it is available for use or additional processing. A source of ambient-temperature air (215) is fed into the dryer.

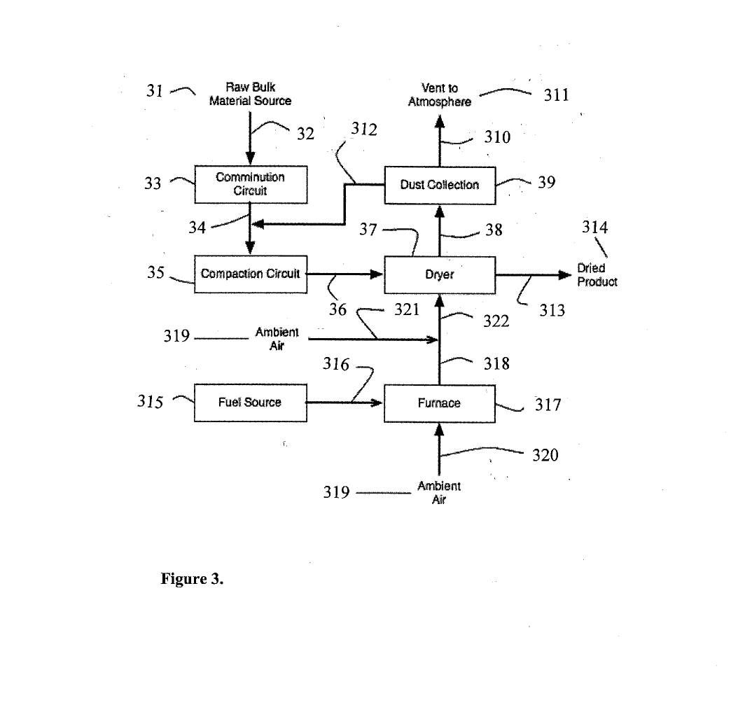

FIG. 3 shows a schematic of the overall system of a preferred embodiment of the invention. A source of raw solid fuel (31) supplies material (32) to the raw solid fuel comminution circuit (33) where the feed is crushed and sized. The prepared raw feed (34) and collected dust (312) is feed to the compaction circuit (35) where it is compressed under high pressure to force water from the feed's internal pores to produce a flake product with water adhering to the surface of the compacted material (36). The compacted material is fed to the dryer (37) where it is mixed with heated air and flue gas (322) thus evaporating the water residing on the surface of the compacted material. The resulting vapors and dust (38) are passed to a dust collection circuit (39) where dust and water vapor are separated. Dust-free vapor (310) is vented to the atmosphere (311). Dust (312) is conveyed to the compaction circuit. Dryer product (313) containing substantially less moisture than the feed, but within the application product specifications, is conveyed to a dried product storage point (314) where it is available for use or additional processing. A source of ambient air (319) provides combustion air (320) and tempering air (321) to the process. A source of fuel (315) is supplied (16) to a furnace (317) where it is combusted to provide hot flue gas (318). The flue gas is mixed with tempering air (321) to provide a warm gas (322) of the specified temperature for drying purposes.

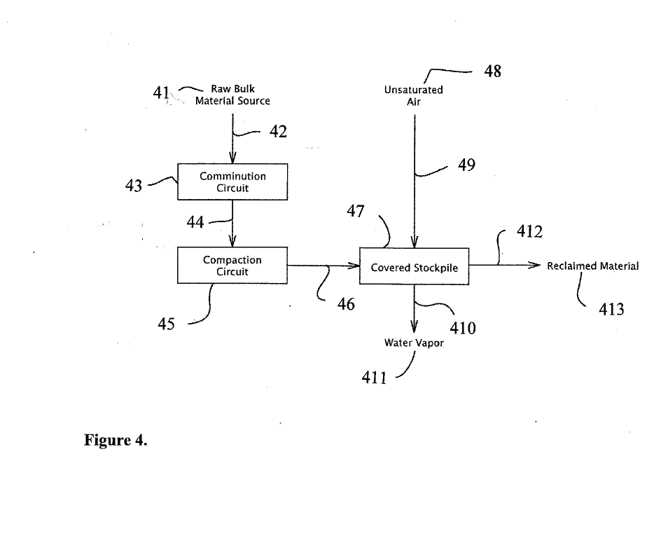

FIG. 4 shows a schematic of a preferred embodiment of the invention. A source of raw solid fuel (41) supplies material (42) to the raw solid fuel comminution circuit (43) where the feed is crushed and sized. The prepared raw feed (44) is feed to the compaction circuit (45) where it is compressed under high pressure to force water from the feed's internal pores to produce a flake product with water adhering to the surface of the compacted material (46). The compacted material is stacked out in a covered stockpile (47). A source of ambient, unsaturated air (48) is available to sweep (49) over the stockpiled material thus evaporating the water residing on the surface of the compacted material. The resulting vapors (410) are released as a gas to the atmosphere (411). Dried product (412) containing substantially less moisture than the feed, but within the application product specifications, is reclaimed to a dried product storage point (413) where it is available for use or additional processing.

Additional objects, advantages, and novel features of this invention will become apparent to those skilled in the art upon examination of the following examples thereof, which are not intended to be limiting.

### EXAMPLES

### Example 1

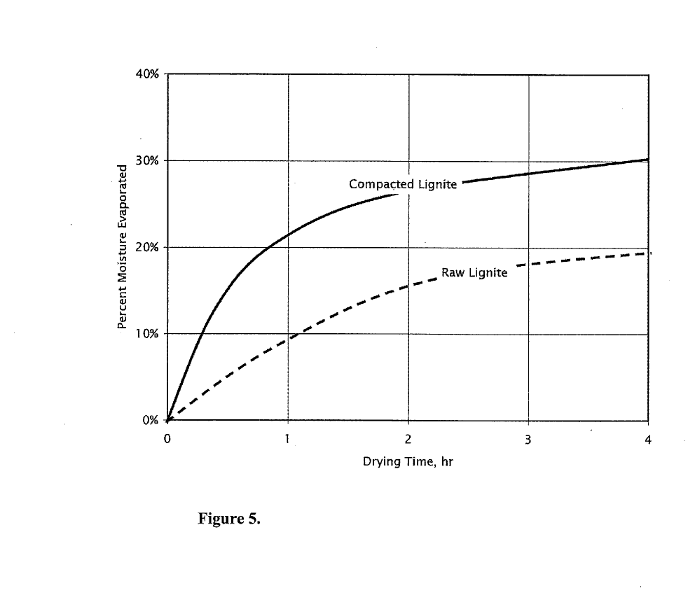

A detailed study of lignite (high-moisture lignite from North Dakota) was undertaken to assess the relative drying rates of raw material and compacted product. Experiments were conducted on materials spread out on a flat tarpaulin at ambient conditions. Samples of raw lignite and compacted lignite were taken periodically from the spread out material and assayed for total moisture. The measured moisture values were normalized as percent of the total water evaporated to compare the results on an equal basis. Drying conditions were 31° C., and 23% relative humidity. Results are plotted in FIG. 5.

These results demonstrate the increased drying rates possible by compacting the raw lignite. Table 1 summarizes the ratio of drying rates between raw and compacted lignite processed at ambient conditions of 31° C., 23% relative humidity.

TABLE 1
Ratio of Relative Drying Rates for North Dakota Lignite

| | |
|---|---|
| Drying Time, | % Moisture Removed |

| hr | Raw | Compacted | Ratio |
|---|---|---|---|
| 0.5 | 4 | 16 | 4.0 |
| 1.0 | 9 | 22 | 2.4 |
| 1.5 | 13 | 26 | 2.0 |
| 2.0 | 16 | 28 | 1.8 |

### Example 2

A detailed study of one LRC (high-moisture lignite from South East Asia) was undertaken to assess the relative drying rates of raw material and compacted product processed by an indirect rotary dryer (180 mm diameter×3000 mm long). The heated portion of the drying tube was 2000 mm long, the cooling zone was 600 mm long, and the feed zone was 400 mm long. Test conditions were identical for the compacted and raw materials. The results are summarized in Table 2.

TABLE 2
Rotary Indirect Dryer Test Results

| | Compacted | Raw |
|---|---|---|
| Test Parameter | Material | Material |
| Feed moisture, wt % | 45 | 46 |
| Product moisture, wt % | 16 | 38 |
| Residence time, min | 20 | 20 |
| Sweep gas temperature, at | 130 | 130 |
| feed point, ° C. | | |
| Shell temperature, ° C. | Less than 110 | Less than 110 |
| Maximum material | Less than 100 | Less than 100 |
| temperature, ° C. | | |
| Sweep gas flow rate, L/min | 700 | 700 |
| Material feed rate, kg/min | 10 | 10 |

These data show the compacted material dries to a lower moisture content that is about half that of the raw material under identical drying conditions. The increased drying rate afforded by compaction effectively doubles the capacity of the drying equipment. If cost savings are more important than capacity, the cost of the drying equipment will be half.

### Example 3

An experiment was conducted to measure the relative drying rates of South East Asia lignite held under warm, moist conditions that would be expected in a covered stockpile located in non-condensing, warm, humid tropical climates. Table 3 lists results.

TABLE 3
Moisture Content of Lignite Stored in Warm, Humid Atmosphere
30° C., >60% Relative Humidity

| | Raw Lignite | Compacted |
|---|---|---|
| | Moisture, | Lignite Moisture, |
| Time, hrs | wt % | wt % |
| 0 | 40 | 43 |
| 48 | 36 | 37 |

These test data show that the compacted material lost 50% more moisture than the raw material in 48 hours.

### Example 4

Samples of lignite produced from North Dakota were processed by the GTLE process to form briquettes of low moisture content. These briquettes were then processed at high temperature and gas conditions that are typical of those found in the reaction zone of a solid feed gasifier.

The compressive strength of the briquettes and associated coke produced from the gasification conditions were measured. Tests were also conducted on briquettes formed from North Dakota lignite by standard industrial processes typically used to form home heating fuels and other industrial products. Test results are listed in Table 4.

TABLE 4
Compressive Strength of Briquettes and Coke Produced from LRCs

| | Briquette | Compressive | | |
|---|---|---|---|---|
| | Moisture, | Strength, lb/in² | | |
| Sample Description | wt % | Briquette | Coke | Process Method |
| North Dakota Lignite | 16.3 | 1,405 | 711 | Present Invention |
| #5 A | | | | |
| North Dakota Lignite | 10.9 | 944 | 676 | Present Invention |
| #5 B | | | | |
| North Dakota Lignite | 12.0 | 1,211 | 898 | Present Invention |
| #6 A | | | | |
| North Dakota Lignite | 9.98 | 767 | 755 | Present Invention |
| #6 B | | | | |
| North Dakota Lignite | 8.24 | 735 | 506 | Present Invention |
| #6 C | | | | |
| German Lignite | 10.81 | n/a | 247 | Industrial Process |

These results demonstrate the increase of compressive strength from 247 lb/in² for coke produced from briquettes formed from industrial processes to over 500 lb/in² for coke produced from briquettes formed by the present invention.

The foregoing description of the present invention has been presented for purposes of illustration and description. Furthermore, the description is not intended to limit the invention to the form disclosed herein. Consequently, variations and modifications commensurate with the above teachings, and the skill or knowledge of the relevant art, are within the scope of the present invention. The embodiment described hereinabove is further intended to explain the best mode known for practicing the invention and to enable others skilled in the art to utilize the invention in such, or other, embodiments and with various modifications required by the particular applications or uses of the present invention. It is intended that the appended claims be construed to include alternative embodiments to the extent permitted by the prior art.

What is claimed is:

1. A method of treating a solid carbonaceous material comprising:
compacting a solid carbonaceous material under a force of at least about 5000 lb/in² to form a compacted carbonaceous material; and,
contacting the compacted carbonaceous material with a working fluid, wherein the working fluid causes evaporative drying of the compacted carbonaceous material to form a dried carbonaceous material.

2. The method of claim 1, wherein the solid carbonaceous material is selected from the group consisting of brown coal, lignite, subbituminous coal and mixtures of these materials.

3. The method of claim 1, wherein the solid carbonaceous material has a top size between about 0.1 mm and about 6 mm.

4. The method of claim 1, wherein the solid carbonaceous material has a moisture content between about 15 weight percent and about 65 weight percent.

5. The method of claim 1, wherein the solid carbonaceous material has a temperature between about 17° C. and about 66° C.

6. The method of claim 1, wherein the force is between about 5000 lb/in² and about 50000 lb/in².

7. The method of claim 1, wherein the working fluid is selected from the group consisting of unsaturated air, nitrogen, inert gas, flue gas, superheated steam and mixtures of these fluids.

8. The method of claim 1, wherein the contacting comprises applying the working fluid to the compacted carbonaceous material in at least one of a stockpile of the compacted carbonaceous material and a rotary dryer containing the carbonaceous material.

9. The method of claim 1, wherein the contacting comprises contacting the compacted carbonaceous material on a conveyor with a working fluid flowing past the conveyed material.

10. The method of claim 1, further comprising collecting dust created in the contacting step and returning the collected dust to a solid carbonaceous material for the compacting step.

11. The method of claim 1, further comprising compacting the dried carbonaceous material to form a shaped compacted material.

12. The method of claim 11, wherein the shaped compacted material is a briquette of ovoid shape with a minor dimension between about 6 mm and about 100 mm.

13. The method of claim 11, wherein the shaped compacted material has a moisture content between about 7 weight percent and about 17 weight percent.
